(19) United States
(12) Patent Application Publication
(10) Pub. No.: US 2015/0039625 A1
(43) Pub. Date: Feb. 5, 2015

(54) Hierarchical Temporal Event Management

(71) Applicant: LOGGLY, INC., SAN FRANCISCO, CA (US)

(72) Inventors: James Donald Nisbet, Menlo Park, CA (US); Jonathan Wade Gifford, San Francisco, CA (US)

(73) Assignee: LOGGLY, INC., SAN FRANCISCO, CA (US)

(21) Appl. No.: 14/167,925

(22) Filed: Jan. 29, 2014

Related U.S. Application Data
(60) Provisional application No. 61/764,990, filed on Feb. 14, 2013.

(51) Int. Cl. G06F 17/30

(52) U.S. Cl. CPC G06F 17/30946; G06F 17/30619
USPC 707/746; 707/736; 707/741

(57) ABSTRACT

Hierarchical temporal event management enables reduction or elimination of synchronization of multiple potentially huge indexes for real-time log indexing. Logs are time series data of events having associated times. Raw events are indexed in a hierarchical index. Transformed, filtered, or aggregated events are indexed in the hierarchical index at a different level of the hierarchy than the raw events. The result is a single hierarchical index that supports queries that optionally cross “level boundaries”, enabling a search on both aggregated information and specific elements. Such searches are usable when generating “drill down” data for graphs and reports. Search requests having corresponding search specifications are received from requestors. In response, a hierarchical event store is searched and results are provided to the requestors. Optionally the results are themselves indexed in a level of the hierarchical index, enabling results of computationally expensive aggregate searches to be stored in the hierarchical index.

### CROSS REFERENCE TO RELATED APPLICATIONS

Priority benefit claims for this application are made in the accompanying Application Data Sheet, Request, or Transmittal (as appropriate, if any). To the extent permitted by the type of the instant application, this application incorporates by reference for all purposes the following applications, all commonly owned with the instant application at the time the invention was made:

U.S. Provisional Application (Docket No. LL-12-01 and Ser. No. 61/764,990), filed Feb. 14, 2013, first named inventor James Donald Nisbet, and entitled HIERARCHICAL TEMPORAL EVENT MANAGEMENT.

### BACKGROUND

1. Field

Advancements in log file processing are needed to provide improvements in cost, profitability, performance, efficiency, and utility of use.

2. Related Art

Unless expressly identified as being publicly or well known, mention herein of techniques and concepts, including for context, definitions, or comparison purposes, should not be construed as an admission that such techniques and concepts are previously publicly known or otherwise part of the prior art. All references cited herein (if any), including patents, patent applications, and publications, are hereby incorporated by reference in their entireties, whether specifically incorporated or not, for all purposes.

### SYNOPSIS

The invention may be implemented in numerous ways, e.g., as a process, an article of manufacture, an apparatus, a system, a composition of matter, and a computer readable medium such as a computer readable storage medium (e.g., media in an optical and/or magnetic mass storage device such as a disk, an integrated circuit having non-volatile storage such as flash storage), or a computer network wherein program instructions are sent over optical or electronic communication links. The Detailed Description provides an exposition of one or more embodiments of the invention that enable improvements in cost, profitability, performance, efficiency, and utility of use in the field identified above. The Detailed Description includes an Introduction to facilitate understanding of the remainder of the Detailed Description. The Introduction includes Example Embodiments of one or more of systems, methods, articles of manufacture, and computer readable media in accordance with concepts described herein. As is discussed in more detail in the Conclusions, the invention encompasses all possible modifications and variations within the scope of the issued claims.

### BRIEF DESCRIPTION OF DRAWINGS

FIG. 1 illustrates selected details of an embodiment of hierarchical temporal event management using a hierarchical event store.

FIG. 2 illustrates selected details of an embodiment of an event index hierarchy.

FIG. 3 illustrates selected details of an embodiment of sub indexes corresponding to fixed time slices for hierarchical temporal event management.

FIG. 4 illustrates selected details of event processing in an embodiment of hierarchical temporal event management.

FIG. 5 illustrates selected details of an embodiment of performing a search in a context of hierarchical temporal event management.

FIG. 6 illustrates selected details of an embodiment of event expiry for hierarchical temporal event management.

List of Reference Symbols in Drawings

| Ref. Symbol | Element Name |
|---|---|
| 100 | Servers |
| 100.1 | Server 1 |
| 100.N | Server N |
| 110 | Requestors |
| 110.1 | Requestor 1 |
| 110.N | Requestor N |
| 121 | Processing System 1 |
| 122 | Processing System 2 |
| 123 | Processing System 3 |
| 139 | Network(s) |
| 141 | Shard 1 |
| 142 | Shard 2 |
| 143 | Shard 3 |
| 150 | Hierarchical Event Store |
| 160 | Unified Index |
| 160.0 | Level 0 |
| 160.1 | Level 1 |
| 160.N | Level N |
| 180 | Events |
| 181 | Requests |
| 182 | Results |
| 191 | Location 1 |
| 192 | Location 2 |
| 200 | Level 0: Raw Events |
| 210 | Level 1: Filtered Events |
| 211 | Filtered Events 1 |
| 212 | Filtered Events 2 |
| 213 | Filtered Events 3 |
| 220 | Level 2: Transformed Events |
| 221 | Transformed Events |
| 230 | Level 3: Aggregated Events |
| 231 | Aggregated Event 1 |
| 232 | Aggregated Event 2 |
| 233 | Aggregated Event 3 |
| 240 | Level 4: Alert Events |
| 241 | Alert Event 1 |
| 242 | Alert Event 2 |
| 250 | Level 5: Community Annotations |
| 251 | Community Annotation 1 |
| 252 | Community Annotation 2 |
| 270 | Unified Logical Index |
| 270.1 | Time Span 1 |
| 270.N | Time Span N |
| 280.1 | Time Interval 1 |
| 280.N | Time Interval N |
| 291 | Event Store Operations 1 |
| 292 | Event Store Operations 2 |
| 300 | Time |
| 301 | Current Time |
| 302 | Retention Time |
| 310 | Sub Indexes |
| 310.0 | Sub Index 0 |
| 310.1 | Sub Index 1 |
| 310.N | Sub Index N |
| 320.0 | Time Interval 0 |
| 320.1 | Time Interval 1 |
| 320.N | Time Interval N |
| 401 | Start |
| 402 | Receive Event(s) |
| 403 | Assign Hierarchy Level(s) |
| 404 | Store in Event Store |
| 405 | Dependents? |
| 406 | Determine Event(s) |
| 499 | End |
| 501 | Start |
| 502 | Receive Search |
| 502H | Hierarchy Level(s) |
| 503 | Search Event Store |
| 504 | Return Results |
| 505 | Save Search? |
| 506 | Num > Threshold? |
| 507 | Store Search Spec |
| 508 | Store Search Results |
| 599 | End |
| 601 | Start |
| 602 | Expired Event(s)? |
| 603 | Remove |
| 604 | Wait |

### DETAILED DESCRIPTION

A detailed description of one or more embodiments of the invention is provided below along with accompanying figures illustrating selected details of the invention. The invention is described in connection with the embodiments. The embodiments herein are understood to be merely exemplary, the invention is expressly not limited to or by any or all of the embodiments herein, and the invention encompasses numerous alternatives, modifications, and equivalents. To avoid monotony in the exposition, a variety of word labels (such as: first, last, certain, various, further, other, particular, select, some, and notable) may be applied to separate sets of embodiments; as used herein such labels are expressly not meant to convey quality, or any form of preference or prejudice, but merely to conveniently distinguish among the separate sets. The order of some operations of disclosed processes is alterable within the scope of the invention. Wherever multiple embodiments serve to describe variations in process, system, and/or program instruction features, other embodiments are contemplated that in accordance with a predetermined or a dynamically determined criterion perform static and/or dynamic selection of one of a plurality of modes of operation corresponding respectively to a plurality of the multiple embodiments. Numerous specific details are set forth in the following description to provide a thorough understanding of the invention. The details are provided for the purpose of example and the invention may be practiced according to the claims without some or all of the details. For the purpose of clarity, technical material that is known in the technical fields related to the invention has not been described in detail so that the invention is not unnecessarily obscured.

### Introduction

This introduction is included only to facilitate the more rapid understanding of the Detailed Description; the invention is not limited to the concepts presented in the introduction (including explicit examples, if any), as the paragraphs of any introduction are necessarily an abridged view of the entire subject and are not meant to be an exhaustive or restrictive description. For example, the introduction that follows provides overview information limited by space and organization to only certain embodiments. There are many other embodiments, including those to which claims will ultimately be drawn, discussed throughout the balance of the specification.

### Acronyms

At least some of the various shorthand abbreviations (e.g. acronyms) defined here refer to certain elements used herein.

| Acronym | Description |
|---|---|
| CPU | Central Processing Unit |
| IP | Internet Protocol |
| K-V | Key-Value |
| LAN | Local Area Network |
| SQL | Structured Query Language |
| URL | Universal Resource Locator |
| WAN | Wide Area Network |

In various embodiments, hierarchical temporal event management enables reduction or elimination of synchronization of multiple indexes. Examples of the multiple indexes are a keyword index for search, an aggregated view in a SQL or K-V database, and externally managed transformation and/or filter logic. In various embodiments, hierarchical temporal event management enables real-time and/or near real-time log indexing. In various embodiments, hierarchical temporal event management enables queries that cross “boundaries”, combining elements of a search and a report. In various embodiments, hierarchical temporal event management enables efficient saving and referencing of aggregated events that span one or more time periods.

In various embodiments of hierarchical temporal event management, raw events are provided to a hierarchical event store. The raw events are provided by an agent separate from the hierarchical event store and/or by the hierarchical event store, in various usage scenarios. Each of the raw events is streamed by the hierarchical event store into a current index of a plurality of indexes as the respective event is received. Derived events are determined based on the raw events and (previously) derived events. The derived events are streamed into the hierarchical event store in a manner similar or identical to the raw events. The streaming of raw and derived events includes adding (to the index) and making searchable. Requests, such as search requests having corresponding search specifications, are received from requestors. In response, the hierarchical event store is searched, results are provided to the requestors, and the results are optionally streamed, as events, into the event store in a manner similar or identical to the raw events. Thus elements to be searched by a query, as well as results of the query, are streamed into a same event store.

The current index is a selected one of a plurality of indexes, the selecting being based, e.g., on time information, such as a timestamp of an event. Raw events are streamed in accordance with a lowest one of a plurality of levels of hierarchy. The derived events are streamed in accordance with other-than the lowest level of hierarchy.

In some embodiments and/or usage scenarios, the streaming of the results as events into the event store is conceptually similar to caching the results in the event store. In some embodiments and/or usage scenarios, particular derived events are determined to enable lower-latency responses to particular queries, e.g., hourly summary events are determined (one summary every hour) to enable a quick response to a query for a daily summary of events.

An example of a hierarchical event store is one or more elements enabled to stream in temporal events, save the temporal events via adding to one or more indexes, determine zero or more temporal events derived from the streamed temporal events, and respond to search requests by returning and optionally saving results of the search requests. A hierarchical event store is temporal, in that each event of the event store has a primary key that is a time (e.g. expressed as timestamp) of the event. A hierarchical event store is hierarchical (e.g. having one or more levels), in that each event of the store is processed in accordance with a respective assigned hierarchical level. A particular event at a particular level of hierarchy of an event store is optionally and/or selectively based only on information from selected other events of the event store, and the selected other events are at relatively lower levels of the hierarchy than the particular event.

An example of a temporal event is a description of an occurrence associated with a (particular) time, such as an entry of a log file. Elsewhere herein, a temporal event is sometimes referred to simply as an ‘event’ or alternatively a ‘transaction’. The primary key for an event is the time of the event. In various situations, the time of the event corresponds to the time at the beginning of the event, the time at the end of the event, or some time in between. An event has either a primary timestamp (such as corresponding to the time of the event) or a time range (such as corresponding to the time at the beginning of the event through the time at the end of the event).

Events are of various types, such as a detail event and an aggregate event. A detail event is based on a single time, e.g. corresponding to a time associated with the detail event. An aggregate event is based on a range of time, e.g. corresponding to a start timestamp and an end timestamp. An example of a detail event is a single entry of a server log file. An example of an aggregate event is a count of a particular type of server log file entries from a start time to an end time. A detail event has a primary timestamp. An aggregate event has a time range, such as a start timestamp and an end timestamp. Optionally, an event has additional timestamps, but only one of the one or more timestamps of the event is the primary key.

Events are managed according to a hierarchy of various (hierarchy) levels. For example, a raw event (e.g. an entry of a server log file) is associated with a conceptually lowest (e.g. base or root) level of the hierarchy. For another example, a derived event (sometimes referred to as a dependent event elsewhere herein) is associated with a conceptually higher level of the hierarchy. For yet another example, a particular derived event is determined from one or more source events, each of the source events being associated with a respective level of a hierarchy. The particular derived event is associated with a level of the hierarchy that is conceptually higher than any of the respective levels of the hierarchy that the source events are associated with.

An example of hierarchical is in accordance with various hierarchy levels. Examples of management are saving and searching. Thus, in a hierarchical event store, events are managed (e.g. saved and/or searched) in accordance with hierarchy levels of the event store.

An example of a log file (sometimes referred to elsewhere herein simply as a ‘log’) is one or more elements of time series data, e.g. a computer log having time ordered transactions. Various (computer) system components and/or applications generate one or more logs wholly or partially concurrently. Logs are of various formats, e.g. text format and/or binary format. An entry of a log provides information (e.g. relevant to one or more system components and/or applications), such as “who”, “what”, and/or “when”. Logs are processed variously to identify and/or extract fields, maintain aggregate counts, and/or maintain a term based search index. Each field is optionally indexed separately and optionally by respective agents, such as any one or more of a database application, a search application, and a NoSQL application. Specific exemplary agents include Apache Lucene, Apache Cassandra, and 10gen MongoDB.

An example of a transform operation (in a context of a hierarchical event store) is processing based on a single event, such as creating a single derived event from a single source event. The derived event is at a conceptually higher level of the hierarchy of the event store than the single source event. A transform, such as converting a portion of a single event from one representation to another, is a specific example of a transform operation. A filter, such as accepting (or rejecting) a single event, is another specific example of a transform operation. An extract of one or more fields of a single event, such as extracting a count value, is yet another specific example of a transform operation. A derived event that is a result of a transform operation is sometimes referred to elsewhere herein as a transformed event. A transformed event is optionally and/or selectively produced immediately upon receipt of a corresponding source event (e.g. in response to reception of the source event).

An example of a aggregate operation (in a context of a hierarchical event store) is processing of a plurality of events, such as creating a single derived event from two or more source events. The derived event is at a conceptually higher level of the hierarchy of the event store than any of the source events. An aggregation, such as counting a number of HTTPS type events, is a specific example of a aggregate operation. A derived event indicating a number of a particular type of event being less than a configurable threshold (e.g. relatively little or no activity from a host), is another specific example of a aggregate operation. A derived event that is a result of a aggregate operation is sometimes referred to elsewhere herein as a aggregate event. A aggregate event has a single associated time, such as corresponding to the most recent of the source events. Optionally, an aggregate event has an associated time span, starting with the earliest of the source events, and continuing to the most recent of the source events. An aggregate event is optionally and/or selectively produced at intervals corresponding to the time span of the aggregate event (e.g. in response to reception of the most recent source event).

### Example Embodiments

In concluding the introduction to the detailed description, what follows is a collection of example embodiments, including at least some explicitly enumerated as “ECs” (Example Combinations), providing additional description of a variety of embodiment types in accordance with the concepts described herein; these examples are not meant to be mutually exclusive, exhaustive, or restrictive; and the invention is not limited to these example embodiments but rather encompasses all possible modifications and variations within the scope of the issued claims and their equivalents.

EC1) A method comprising:
receiving, by an event store, one or more events;
associating each of the received events with a respective hierarchical level;
saving, in the event store, the received events in accordance with the respective hierarchical levels; and
determining one or more derived events based at least in part on one or more of the received events.

EC2) The method of EC1, wherein the respective hierarchical levels comprise a base hierarchical level and one or more additional hierarchical levels.

EC3) An apparatus comprising:
a networking sub-system enabled to receive one or more events via one or more networks;
a storage sub-system enabled to save representations of the received events;
a processing sub-system coupled to the networking sub-system and the storage sub-system; and
wherein the processing sub-system is enabled to
   associate each of the received events with a respective hierarchical level,
   save, in the processing sub-system, the received events in accordance with the respective hierarchical levels, and
   determine one or more derived events based at least in part on one or more of the received events.

EC4) The apparatus of EC3, wherein the respective hierarchical levels comprise a base hierarchical level and one or more additional hierarchical levels.

EC5) A tangible computer readable medium having a set of instructions stored therein that when executed by a processing element cause the processing element to perform and/or control operations comprising:
receiving, by an event store, one or more events;
associating each of the received events with a respective hierarchical level;
saving, in the event store, the received events in accordance with the respective hierarchical levels; and
determining one or more derived events based at least in part on one or more of the received events.

EC6) The tangible computer readable medium of EC5, wherein the respective hierarchical levels comprise a base hierarchical level and one or more additional hierarchical levels.

EC7) A system comprising:
means for receiving, by an event store, one or more events;
means for associating each of the received events with a respective hierarchical level;
means for saving, in the event store, the received events in accordance with the respective hierarchical levels; and
means for determining one or more derived events based at least in part on one or more of the received events.

EC8) The system of EC7, wherein the respective hierarchical levels comprise a base hierarchical level and one or more additional hierarchical levels.

### Operating Context

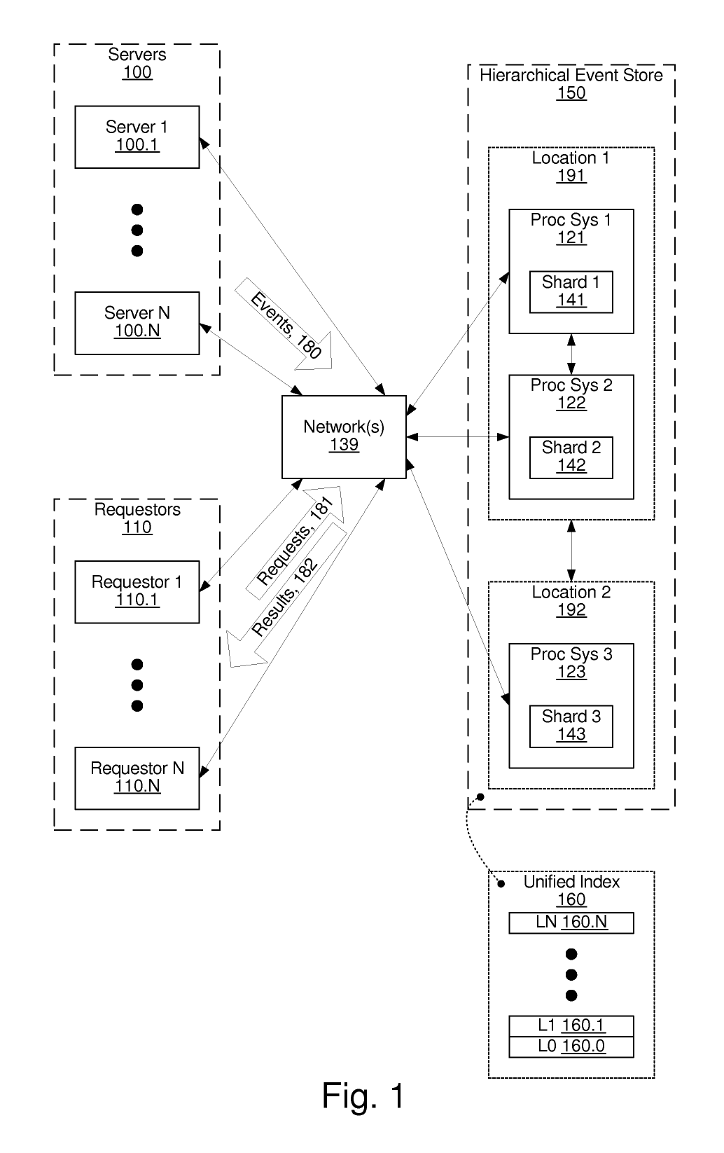

FIG. 1 illustrates selected details of an embodiment of hierarchical temporal event management using a hierarchical event store. The hierarchical temporal event management is provided by Hierarchical Event Store 150 having storage implemented by Unified Index 160. Servers 100 and Hierarchical Event Store 150 are coupled via Network(s) 139. Requestors 110 and Hierarchical Event Store 150 are coupled via Network(s) 139.

Servers 100 includes a plurality of servers illustrated conceptually by Server 1 100.1 . . . . Server N 100.N. Requestors 110 includes a plurality of requestors illustrated conceptually by Requestor 1 110.1 . . . . Requestor N 110.N. Hierarchical Event Store 150 includes various processing systems situated in a plurality of locations illustrated conceptually by Location 1 191 and Location 2 192. Location 1 191 includes a plurality of processing systems illustrated conceptually by Processing System 1 121 and Processing System 2 122. Location 2 192 includes Processing System 3 123. Processing Systems 121, 122, and 123 respectively include Shards 141, 142, and 143. Unified Index 160 retains (e.g. adds and/or makes searchable) events in accordance with a plurality of hierarchical levels illustrated conceptually as Level 0 160.0 (the ‘lowest’ level of the hierarchy), Level 1 160.1 (the level adjacently ‘above’ the lowest level) . . . and Level N 160.N (the ‘highest’ level of the hierarchy).

Examples of all or any portions of the Servers and/or the Processing Systems are elements of compute, data, and storage centers, such as computers and/or computer systems. Further examples of the Servers and/or the Processing Systems are computers, such as workstation computers, supercomputers, and personal computers and/or systems of computers. Other examples of the Servers are any element and/or agent enabled to provide one or more events to a network, such as one or more entries of one or more log files. Other examples of the Processing Systems are any element and/or agent enabled to receive events, manage the events in accordance with a hierarchy, receive requests relating to the managed events, and return results relating to the requests.

Examples of the Requestors are users, such as humans, and automated agents, such as any element enabled to provide one or more requests to a network and/or to receive results of requests from a network. In some embodiments and/or usage scenarios, at least one of the Requestors is implemented via one or more software programs executing on a programmable element (e.g. a CPU). In some embodiments and/or usage scenarios, at least one of the Requestors is partially implemented via at least one of the Servers (e.g. a compute server executes a program that provides requests to and receives results of the requests from a network). In some embodiments and/or usage scenarios, at least one of the Requestors is partially implemented via elements similar or identical to elements of least one of the Servers (e.g. a personal computer provides a user with a capability to enter a request and view results of the request).

Storage for events is via the Shards, e.g. adding an event to the Unified Index is at least in part via writing information to at least one of the Shards. In various embodiments all or any portions of any one or more of the Shards is provided via any one or more of: optical storage, magnetic storage, and solid state storage. In various embodiments, a single processing system includes a plurality of shards. In some embodiments, shards correspond to storage associated with one or more time ranges. For example, a first shard corresponds to midnight to 1 am, a second shard to 1 am to 2 am, and so forth for all 24 hours of a day. In some embodiments (not illustrated), all storage associated with the Hierarchical Event Store is implemented in a single element (e.g. what would otherwise be implemented in a plurality of shards is implemented in a single store).

In various embodiments, the Network(s) include any one or more of the Internet and one or more LANs, WANs, wired networks, and wireless networks.

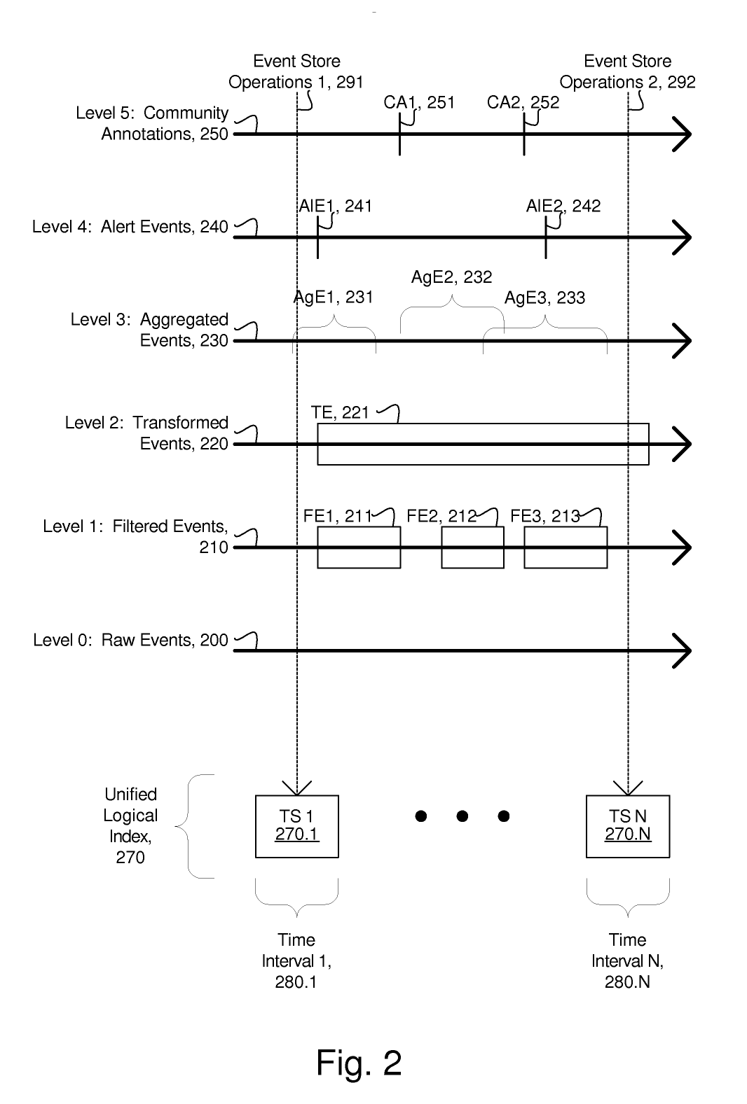

In overview, operation of the elements of FIG. 1 is as follows. Elements of Servers 100 generate events (e.g. log file entries) that are provided via Network(s) 139 to Hierarchical Event Store 150, as illustrated conceptually by arrow Events 180. In response, Hierarchical Event Store 150 processes the events. The processing includes saving the events via adding the events to Unified Index 160, and optionally and/or selectively generating one or more derived events based at least in part on the received events. The derived events are saved via adding to Unified Index 160. Elements of Requestors 110 generate requests such as a search request having an associated search specification that are provided via Network(s) 139 to Hierarchical Event Store 150, as illustrated conceptually by arrow Requests 181. Example requests and/or search specifications are “how many HTTPS requests occurred yesterday” and “show events associated with IP addresses of a particular range”. In response to the requests, Hierarchical Event Store 150 processes the requests (e.g. via searching Shards 141, 142, and/or 143) and provides results via Network(s) 139, as illustrated conceptually by arrow Results 182. Optionally and/or selectively, Hierarchical Event Store 150 saves the results via adding the results to Unified Index 160. FIGS. 2-6 and associated descriptions provide additional information regarding operation and attributes of various elements of FIG. 1.

In various embodiments a hierarchical event store is implemented any of: entirely in a single location having one or more processing systems, via a plurality of co-located processing systems, and via a plurality of processing systems located in a plurality of geographical locations. In various embodiments, storage associated with a hierarchical event store is implemented via any one of: a single physical storage device, a plurality of physical storage devices in a single location, and a plurality of storage devices in a plurality of locations.

FIG. 2 illustrates selected details of an embodiment of an event index hierarchy. In the figure, time increases from left to right (e.g. times in the past are to the far left, and times in the future are to the far right). As illustrated, the event index hierarchy includes various levels. The conceptually ‘lowest’ level of the event index hierarchy (or simply ‘event hierarchy’) is Level 0: Raw Events 200. The next level ‘up’ the event hierarchy is Level 1: Filtered Events 210. Successively ‘higher’ levels are respectively Level 2: Transformed Events 220, Level 3: Aggregated Events 230, and Level 4: Alert Events 240. The highest level of the event hierarchy is Level 5: Community Annotations 250.

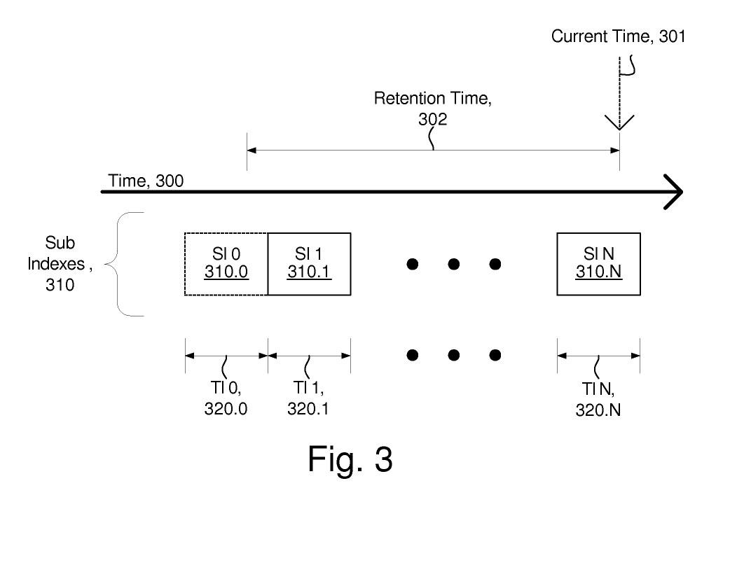

Unified Logical Index 270 is an index configured to add and/or make searchable events in accordance with hierarchy levels 200, 210, 220, 230, 240, and 250. Unified Logical Index 270 is organized and managed as a plurality of time spans (Time Span 1 270.1 and so forth as illustrated by ellipses through Time Span N 270.N) corresponding to respective time intervals (Time Interval 1 280.1 being the oldest and so forth through Time Interval N 280.N being the most recent or alternatively current). In some embodiments, each of the time spans corresponds to a respective sub index (e.g. elements of Sub Indexes 310 of FIG. 3). In some embodiments, each of the time spans is of a same length (e.g. one hour).

Operations upon and/or relating to the even index hierarchy are illustrated conceptually by Event Store Operations 1 291 directed to Time Span 1 270.1 and Event Store Operations 2 292 directed to Time Span N 270.N. All operations of Event Store Operations 1 291 occur earlier than any operations of Event Store Operations 2 292. The operations include adding an event (to a time span), and/or determining one or more derived events.

Derived events at a particular level of the hierarchy are determined from events at lower levels of the hierarchy. Therefore, events of Level 1: Filtered Events 210 (Filtered Events 1 211, Filtered Events 2 212, and Filtered Events 3 213) are determined from event information solely from Level 0: Raw Events 200. Further, Transformed Events 221 is determined from event information solely from any one or more of 210 and 200 (e.g. 210). Still further, Aggregated Event 1 231, Aggregated Event 2 232, and Aggregated Event 3 233 are determined solely from event information from any one or more of 220, 210, and 200. Still further, Alert Event 1 241 and Alert Event 2 242 are determined solely from event information from any one or more of 230, 220, 210, and 200. Lastly, Community Annotation 1 251 and Community Annotation 2 252 are determined solely from event information from any one or more of 240, 230, 220, 210, and 200.

Examples of (raw) events at Level 0: Raw Events 200 are an entry of a server log file (e.g. from any of Servers 100 of FIG. 1) and a search specification (e.g. from any of Requestors 110 of FIG. 1). Examples of (derived) events at Level 1: Filtered Events 210 are events of 200 that correspond to some type of error and/or particular identifier (such as a specific URL or IP address). Examples of (derived) events at Level 2: Transformed Events 220 are events of 210 modified to a canonical representation (such as a binary encoding of an IP address and a string encoding of a URL) and/or a compressed representation. Examples of (derived) events at Level 3: Aggregated Events 230 are counts of a particular type of activity and ranges of IP addresses as described by events of 220. Examples of (derived) events at Level 4: Alert Events 240 are an event indicating that a particular count as recorded by one or more events of 230 is above (or below) a configurable threshold, and an event indicating that a particular event of 200 is in an invalid and/or unrecognized format. Examples of events at Level 5: Community Annotations 250 include an indication that “a server location is flooded” and an indication that “a server has had no alerts for a week” as derived from event information of 240.

Time ranges associated with one or more aggregated events are any one or more of non-overlapping, entirely overlapping, and partially overlapping with respect to each other, according to various embodiments and/or usage scenarios. In the figure, the respective downward-facing curly bracket of each of the illustrated Aggregated Events is indicative of a respective time range. For example, the time range of Aggregated Event 1 231 is non-overlapping with respect to the time ranges of Aggregated Event 2 232 and Aggregated Event 3 233. For another example, the time ranges of Aggregated Event 2 232 and Aggregated Event 3 233 partially overlap.

In some embodiments and/or usage scenarios, all or any portions of events at one or more hierarchy levels are not determined from event information. For example, a community annotation event such as “power is out in Chicago” is not determined from event information.

In various embodiments, all or any portions of elements illustrated in FIG. 2 correspond to all or any portions of and/or elements associated with Hierarchical Event Store 150 of FIG. 1. For example, Level 0: Raw Events 200, Level 1: Filtered Events 210, and Level 5: Community Annotations 250 correspond respectively to Level 0 160.0, Level 1 160.1, and Level N 160.N of FIG. 1. For another example, Unified Logical Index 270 corresponds to Unified Index 160 of FIG. 1.

FIG. 3 illustrates selected details of an embodiment of sub indexes corresponding to fixed time slices for hierarchical temporal event management. The figure is illustrated with time conceptually proceeding from the past, through the current instant, to the future from left to right by a bold-arrow horizontal axis Time 300. A current time is indicated by dashed vertical arrow Current Time 301. Sub Indexes 310 represents an embodiment of storage for a hierarchical event store (e.g. Hierarchical Event Store 150 of FIG. 1) and/or an embodiment corresponding to a unified (logical) index (e.g. Unified Logical Index 270 of FIG. 2). Sub Indexes 310 includes respective sub indexes (Sub Index 0 310, Sub Index 1 310.1 . . . . Sub Index N 310.N) corresponding respectively to a plurality of time intervals (Time Interval 0 320, Time Interval 1 320.1 . . . . Time Interval N 320.N). In some embodiments, each of the time intervals are of identical length, e.g. one day. An amount of time that information added to the sub indexes is to be retained is illustrated by Retention Time 302. Thus, information of Sub Index N 310.N ‘backward’ in time through and including Sub Index 1 310.1 is retained, and information of Sub Index 0 310.0 is not retained (e.g. storage used for Sub Index 0 310.0 is freed).

For example, each of the time intervals is one day, each of the corresponding sub indexes thus has information for one day, and the retention time is one week. The current day is Sunday, and therefore sub indexes corresponding to the previous week (the previous Saturday backward through the previous Sunday) are retained. When time advances so that the current day becomes Monday, the sub index having information for the oldest of the two Sundays is no longer retained (e.g. it is delete, removed, and/or corresponding/allocated storage freed).

### Operation

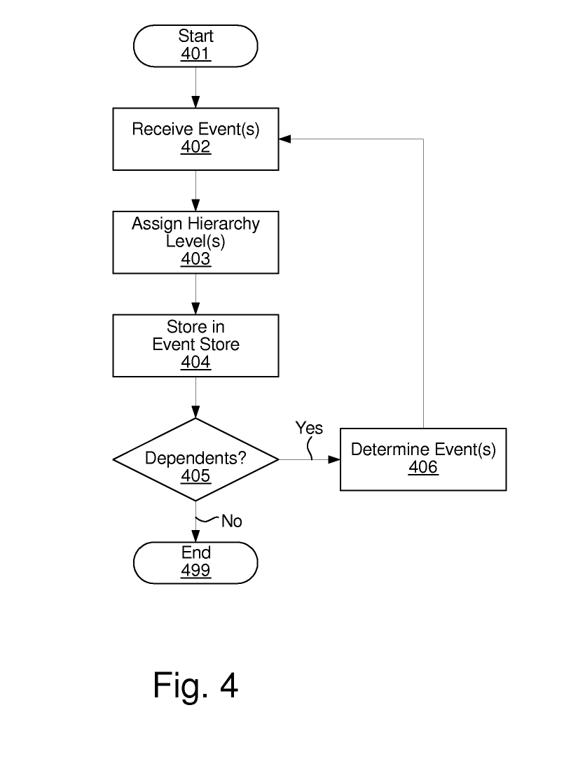

FIG. 4 illustrates selected details of event processing in an embodiment of hierarchical temporal event management. In overview, events are received and processed. The processing includes saving the events, in accordance with an assigned hierarchy level, into a hierarchical event store. The processing further includes determining zero or more derived events that are based at least in part on the received events.

More specifically, processing begins (Start 401) and continues upon reception of one or more events (Receive Event(s) 402). The processing then proceeds to determine respective hierarchy levels for each of the received events (Assign Hierarchy Level(s) 403). Then the events are saved in the hierarchical event store (Store in Event Store 404) in accordance with the determined hierarchy levels, e.g. by adding the events to one or more indexes that implement the event store. Next a determination is made as to whether there are any derived events that depend on the received events (Dependents? 405). If not, then the processing is complete (End 499). If there are any derived events, then the processing proceeds to create the derived events (Determine Event(s) 406). The processing then loops back to ‘insert’ the derived events as received events (Receive Event(s) 402).

The illustrated processing is applicable, for example, to Events 180 and Hierarchical Event Store 150 of FIG. 1, as well as elements associated with same. The illustrated processing is further applicable, for example, to Event Store Operations 1 291, Event Store Operations 2 292, and Unified Logical Index 270 of FIG. 2, as well as elements associated with same. More specifically, in various embodiments and/or usage scenarios, the aforementioned reception of events corresponds to one or more elements of Events 180 of FIG. 1, and the aforementioned hierarchy levels correspond to Level 0 160.0, Level 1 160.1, and Level N 160.N of Unified Index 160 that implements storage of events for Hierarchical Event Store 150, of FIG. 1. In various embodiments and/or usage scenarios, the aforementioned saving of events corresponds to all or any portions of any one or more of Event Store Operations 1 291 and Event Store Operations 2 292 of FIG. 2. In various embodiments and/or usage scenarios, the aforementioned derived events correspond to any one or more elements of any one or more of Level 5: Community Annotations 250, Level 4: Alert Events 240, Level 3: Aggregated Events 230, Level 2: Transformed Events 220, and Level 1: Filtered Events 210 of FIG. 2.

In various embodiments, one or more of the events received are optionally accompanied by respective identifications of one or more levels of hierarchy associated with the events. In some embodiments, the determining of respective hierarchy levels for the received events is optionally and/or selectively based at least in part on the accompanying respective identifications of the levels of hierarchy. For example, in a context having an event store with at least a ‘level 0’ (or alternatively a ‘raw’) hierarchy level, a raw event that is received is identified as a ‘level 0’ (or alternatively a ‘raw’) event. In response, the event is assigned to the ‘level 0’ (or alternatively the ‘raw’) hierarchy level of the event store (Assign Hierarchy Level(s) 403). For another example, consider a context having an event store with various levels of hierarchy corresponding to ‘level 1’ (or alternatively ‘filtered events’), ‘level 2’ (or alternatively ‘transformed events’), ‘level 3’ (or alternatively ‘aggregated events’), ‘level 4’ (or alternatively ‘alert events’), and ‘level 5’ (or alternatively ‘community annotations’). An event that is determined (Determine Event(s) 406) is provided for reception (Receive Event(s) 402) with identification of one of the aforementioned levels, and the identification is used as a specification for a level of hierarchy of the event store to save the received event in accordance with (Store in Event Store 404).

In various embodiments and/or usage scenarios, one or more of the derived events are “transformed” events (e.g. transform and/or filter events) and/or aggregate events.

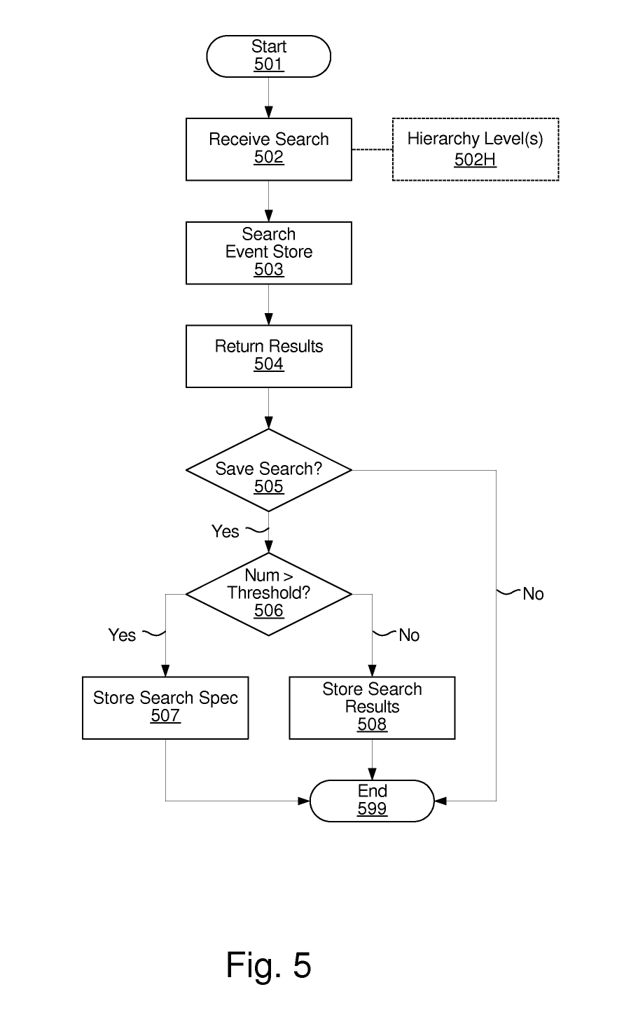

FIG. 5 illustrates selected details of an embodiment of performing a search in a context of hierarchical temporal event management. In overview, a search having a search specification is received, a hierarchical event store is searched based on the search specification, and results are returned and optionally saved in the hierarchical event store.

More specifically, processing begins (Start 501) and continues upon reception of a search request, e.g., a query (Receive Search 502). In some embodiments and/or usage scenarios, the search request is accompanied by an identification of one or more levels of hierarchy associated with the event (Hierarchy Level(s) 502H). Then the search request is performed by determining which (if any) events in the event store match the query (Search Event Store 503). Matching events are then provided (Return Results 504). Then a determination is made as to whether or not the query is to be saved (Save Search? 505). If not, then the processing is complete (End 599).

If the query is to be saved, then the processing proceeds to determine if the number of results of the query (e.g. the number of entries in the event store matching the query) is more than a programmable and/or configurable value (Num > Threshold? 506). If not, then the search results are saved in the event store (Store Search Results 508), e.g. by adding the results as one or more events in one or more indexes that implement the event store. The processing is then complete (End 599). If the number of results of the query is more than a programmable and/or configurable value, then the processing proceeds to save the search request (e.g. including the search specification) as one or more events in the event store (Store Search Spec 507). The processing is then complete (End 599). The search request is saved in sufficient detail to enable reproducing the search results via a subsequent search of the event store using the saved search request. Thus in some embodiments and/or usage scenarios, storage used for saving queries is reduced by saving the search request instead of the search results. In some embodiments and/or usage scenarios, a search request (e.g. including a search specification) is saved (e.g. as one or more events in an event store) independently of whether results of the search request are also saved in the event store, enabling, for example, performing the search request on events received in the future.

The illustrated processing is applicable, for example, to Hierarchical Event Store 150 and associated Unified Index 160 of FIG. 1, as well as elements associated with same. The illustrated processing is further applicable, for example, to Unified Logical Index 270 of FIG. 2, as well as elements associated with same. More specifically, in various embodiments and/or usage scenarios, the aforementioned search request corresponds to one or more elements of Requests 181 of FIG. 1, and the aforementioned search results correspond to one or more elements of Results 182 of FIG. 1. In various embodiments and/or usage scenarios, a saved search (whether saved as a search request or explicit search results) corresponds to any one or more elements of any one or more of Level 5: Community Annotations 250, Level 4: Alert Events 240, Level 3: Aggregated Events 230, Level 2: Transformed Events 220, and Level 1: Filtered Events 210 of FIG. 2. In various embodiments and/or usage scenarios, the aforementioned saving of the search results in the event store corresponds to all or any portions of any one or more of Event Store Operations 1 291 and Event Store Operations 2 292 of FIG. 2.

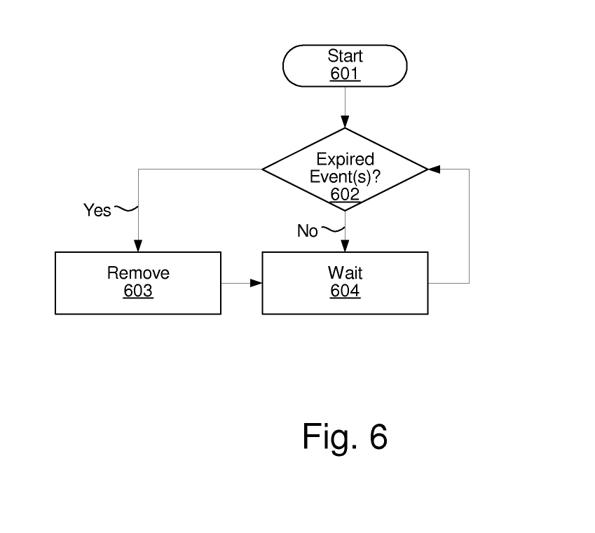

FIG. 6 illustrates selected details of an embodiment of event expiry for hierarchical temporal event management. In overview, events are retained in a hierarchical event store and removed from the hierarchical event store after a specified length of time. More specifically, processing begins (Start 601) and proceeds to determine if there are any saved events that are not to be saved any longer (Expired Event(s)? 602). If so, then the expired events are deleted (Remove 603), e.g. by freeing storage used by the expired events. The processing then proceeds to pause for an amount of time (Wait 604). If there are no expired events, e.g. all currently saved events are to be retained, then the processing pauses for an amount of time (Wait 604). After the pause, the processing loops back to again determine if there are any saved events that are not to be saved any longer (Expired Event(s)? 602).

The illustrated processing is applicable, for example, to Unified Index 160 of FIG. 1, Unified Logical Index 270 of FIG. 2, and/or Sub Indexes 310 of FIG. 3, according to various embodiments. More specifically, deleting expired events (Remove 603) corresponds, in various embodiments, to removing portions of Unified Index 160 that contain expired events, removing an oldest one of the time spans of Unified Logical Index 270 (e.g. Time Span 1 270.1), and/or removing Sub Index 0 310.0 of Sub Indexes 310. In various embodiments represented by FIG. 2, determining if there are expired events includes ascertaining if an oldest time interval (e.g. Time Interval 1 280.1) is entirely expired, such as if all events of the oldest time interval are expired. Removing the expired events includes removing all of the events of the oldest time interval together (e.g. as an atomic operation directed to all hierarchy levels), such as by removing Time Span 1 270.1 from Unified Logical Index 270. In various embodiments represented by FIG. 3, determining if there are expired events includes ascertaining if an oldest time interval (Time Interval 0 320) is entirely expired, such as if all events of the oldest time interval are expired. Removing the expired events includes removing all of the events of the oldest time interval together (e.g. as an atomic operation directed to all hierarchy levels), such as by removing Sub Index 0 310.0 from Sub Indexes 310.

According to various embodiments and/or usage scenarios, all or any portions of processing as illustrated, e.g., by any one or more of FIGS. 4-6, are performed by various elements of one or more processing systems (e.g. Processing System 1 121, Processing System 2 122, and Processing System 3 123 of FIG. 1). In various embodiments, all or any portions of the processing illustrated, e.g., by any one or more of FIGS. 4-6, is performed by any one or more of a CPU executing programmed software, firmware, and/or microcode, and one or more hardware accelerators (e.g. an application specific integrated circuit).

In various embodiments and/or usage scenarios, a plurality of hierarchical event stores are implemented by a same set of processing system capabilities. Optionally and/or selectively, various ones of the hierarchical event stores correspond to respective clients. In various embodiments and/or usage scenarios, a same hierarchical event store is used to manage events, requests, and results corresponding to a plurality of clients. In various embodiments and/or usage scenarios, all or any portions of processing as illustrated by FIGS. 4-6 is provided to clients as a service.

### Level of Hierarchy Identification Techniques

As described elsewhere herein, a hierarchical event store provides management of events in accordance with a plurality of hierarchical levels. Various embodiments identify the hierarchical levels and relationships between the hierarchy levels using various techniques, such as numerical and/or string techniques. The relationships include whether a particular hierarchy level is conceptually “above” other one or more hierarchy levels (e.g. events of the particular hierarchy level are dependent upon the other hierarchy levels).

In the following table, the Level column is representative of some of the numerical techniques and the Name column is representative of some of the string techniques. Events of Level 11 (alternatively identified to as “/transaction/session”) are per-session aggregate events derived from events of Level 10 (alternatively identified as “/transaction”).

| Level | Name |
|---|---|
| 31 | /note/twitter |
| 30 | /note/user |
| 21 | /alert/notify |
| 20 | /alert |
| 11 | /transaction/session |
| 10 | /transaction |
| 2 | /transformed |
| 1 | /filtered |
| 0 | /raw |

Some embodiments using one or more of the numerical techniques identify each hierarchical level via any one or more of an integer, a fixed point number, a binary coded decimal number, or any other suitable number. In some embodiments, numerical comparisons between the numerical identifiers indicate relative levels of a hierarchy, e.g. a lower numerical value corresponds to a lower level of the hierarchy. In some embodiments, a maximum number and/or assignment/allocation of hierarchy levels is known a priori, and integers are used to identify the hierarchy levels (as exemplified in the foregoing table by the Level column). In some embodiments, a lowest level of a hierarchy is identified by a zero numerical value.

Some embodiments using one or more of the string techniques identify each hierarchy level via one or more text strings. In some embodiments, a particular one or more characters and/or a string, such as a slash (e.g. “/”) or a period (e.g. “.”) is used to delimit hierarchy levels in a string identifier (as exemplified in the foregoing table by the Name column). As an example, a particular hierarchy level is identified by the string “/transaction”. One or more events derived from events of the “/transaction” level are created and are identified by the string “/transaction/session”.

In some embodiments, a single hierarchical event store is enabled to manage events in accordance with a single hierarchy (e.g. as illustrated by Unified Index 160 of Hierarchical Event Store 150 of FIG. 1). In other embodiments, a hierarchical event store is enabled to manage events in accordance with a plurality of hierarchies, each of the hierarchies having respective hierarchy levels (e.g. such as a plurality of elements similar to Unified Index 160). In some of the embodiments with a hierarchical event store that is enabled to manage events in accordance with a plurality of hierarchies, one or more string techniques are used to identify hierarchy levels via one or more text strings.

Conceptually, the text strings are operative, in some embodiments, to implement one or more namespaces as used in programming. With respect to the foregoing table, “/alert” is above a root identified as “/”, and “/alert/notify” is above “/alert”. Similarly “/transaction” is above the root and “/transaction/session” is above “/transaction”. Further with respect to the foregoing table, “/note/twitter” and “/note/user” correspond to two hierarchical levels used to group similar types of information (without specific hierarchical meaning) such as to avoid name collisions. As a specific example, “/note/twitter” is used to collect tweets about a specific company, and “/note/support” is used to collect tweets having a hashtag that includes ‘#support’.

### Other Embodiment Description

In various embodiments, saving an event in an event store (or alternatively adding an event to an index) includes saving (adding) the event value (e.g. “2000nov04 HTTPS://yahoo.com ping timeout”). In other embodiments, saving an event in an event store (adding to an index) includes saving (adding) a reference to the event value rather than the event value itself (e.g. FTP://EventStore.com/event100) that identifies information having a value of “2000nov04 HTTPS://yahoo.com ping timeout”).

### Example Implementation Techniques

In some embodiments, various combinations of all or any portions of operations performed for hierarchical temporal event management and portions of a processor, microprocessor, system-on-a-chip, application-specific-integrated-circuit, hardware accelerator, or other circuitry providing all or portions of the aforementioned operations, are specified by a specification compatible with processing by a computer system. The specification is in accordance with various descriptions, such as hardware description languages, circuit descriptions, netlist descriptions, mask descriptions, or layout descriptions. Example descriptions include: Verilog, VHDL, SPICE, SPICE variants such as PSpice, IBIS, LEF, DEF, GDS-II, OASIS, or other descriptions. In various embodiments, the processing includes any combination of interpretation, compilation, simulation, and synthesis to produce, to verify, or to specify logic and/or circuitry suitable for inclusion on one or more integrated circuits. Each integrated circuit, according to various embodiments, is compatible with design and/or manufacture according to a variety of techniques. The techniques include a programmable technique (such as a field or mask programmable gate array integrated circuit), a semi-custom technique (such as a wholly or partially cell-based integrated circuit), and a full-custom technique (such as an integrated circuit that is substantially specialized), any combination thereof, or any other technique compatible with design and/or manufacture of integrated circuits.

In some embodiments, various combinations of all or portions of operations as described by a computer readable medium having a set of instructions stored therein, are performed by execution and/or interpretation of one or more program instructions, by interpretation and/or compiling of one or more source and/or script language statements, or by execution of binary instructions produced by compiling, translating, and/or interpreting information expressed in programming and/or scripting language statements. The statements are compatible with any standard programming or scripting language (such as C, C++, Fortran, Pascal, Ada, Java, VBscript, and Shell). One or more of the program instructions, the language statements, or the binary instructions, are optionally stored on one or more computer readable storage medium elements. In various embodiments, some, all, or various portions of the program instructions are realized as one or more functions, routines, sub-routines, in-line routines, procedures, macros, or portions thereof.

### CONCLUSION

Certain choices have been made in the description merely for convenience in preparing the text and drawings, and unless there is an indication to the contrary, the choices should not be construed per se as conveying additional information regarding structure or operation of the embodiments described. Examples of the choices include: the particular organization or assignment of the designations used for the figure numbering and the particular organization or assignment of the element identifiers (the callouts or numerical designators, e.g.) used to identify and reference the features and elements of the embodiments.

The words “includes” or “including” are specifically intended to be construed as abstractions describing logical sets of open-ended scope and are not meant to convey physical containment unless explicitly followed by the word “within.”

Although the foregoing embodiments have been described in some detail for purposes of clarity of description and understanding, the invention is not limited to the details provided. There are many embodiments of the invention. The disclosed embodiments are exemplary and not restrictive.

It will be understood that many variations in construction, arrangement, and use are possible consistent with the description, and are within the scope of the claims of the issued patent. For example, interconnect and function-unit bit-widths, clock speeds, and the type of technology used are variable according to various embodiments in each component block. The names given to interconnect and logic are merely exemplary, and should not be construed as limiting the concepts described. The order and arrangement of flowchart and flow diagram process, action, and function elements are variable according to various embodiments. Also, unless specifically stated to the contrary, value ranges specified, maximum and minimum values used, or other particular specifications (such as file types; and the number of entries or stages in registers and buffers), are merely those of the described embodiments, are expected to track improvements and changes in implementation technology, and should not be construed as limitations.

Functionally equivalent techniques known in the art are employable instead of those described to implement various components, sub-systems, operations, functions, routines, sub-routines, in-line routines, procedures, macros, or portions thereof. It is also understood that many functional aspects of embodiments are realizable selectively in either hardware (e.g., generally dedicated circuitry) or software (e.g., via some manner of programmed controller or processor), as a function of embodiment dependent design constraints and technology trends of faster processing (facilitating migration of functions previously in hardware into software) and higher integration density (facilitating migration of functions previously in software into hardware). Specific variations in various embodiments include, but are not limited to: differences in partitioning; different form factors and configurations; use of different operating systems and other system software; use of different interface standards, network protocols, or communication links; and other variations to be expected when implementing the concepts described herein in accordance with the unique engineering and business constraints of a particular application.

The embodiments have been described with detail and environmental context well beyond that required for a minimal implementation of many aspects of the embodiments described. Those of ordinary skill in the art will recognize that some embodiments omit disclosed components or features without altering the basic cooperation among the remaining elements. It is thus understood that much of the details disclosed are not required to implement various aspects of the embodiments described. To the extent that the remaining elements are distinguishable from the prior art, components and features that are omitted are not limiting on the concepts described herein.

All such variations in design are insubstantial changes over the teachings conveyed by the described embodiments. It is also understood that the embodiments described herein have broad applicability to other computing and networking applications, and are not limited to the particular application or industry of the described embodiments. The invention is thus to be construed as including all possible modifications and variations encompassed within the scope of the claims of the issued patent.

What is claimed is:

1. A method comprising:
receiving, by an event store, one or more events;
associating each of the received events with a respective hierarchical level;
storing, in the event store, the received events in accordance with the respective hierarchical levels; and
determining one or more derived events based at least in part on one or more of the received events.

2. The method of claim 1, wherein the respective hierarchical levels comprise a base hierarchical level and one or more additional hierarchical levels.

3. The method of claim 2, wherein the respective hierarchical levels are indicated by respective distinct text string values.

4. The method of claim 3, wherein the respective distinct text string values are compatible with parsing to determine a relative location in a hierarchy comprising the respective hierarchical levels.

5. The method of claim 2, wherein the respective hierarchical levels are indicated by respective distinct numerical values.

6. The method of claim 5, wherein the respective distinct numerical values are integer numbers.

7. The method of claim 2, wherein at least some of the received events are base events from an agent that is distinct from the event store, and the associating associates the base events with the base hierarchical level.

8. The method of claim 7, wherein the agent is a server, and at least one of the base events comprises a log entry of the server.

9. The method of claim 2, wherein at least some of the received events are the derived events, and the associating associates the derived events with one or more of the additional hierarchical levels.

10. The method of claim 9, wherein at least one of the derived events comprises a result of one or more of
a transform of at least one of the received events,
a filter of at least one of the received events, and
an extract of one or more fields of at least one of the received events.

11. The method of claim 9, wherein each of the events stored in the event store and associated with a particular hierarchical level of the respective hierarchical levels is determinable without information of others of the events stored in the event store and associated with the particular hierarchical level.

12. The method of claim 11, wherein each of the events stored in the event store and associated with the particular hierarchical level is determinable without information of others of the events stored in the event store and associated with ones of the respective hierarchical levels that are above the particular hierarchical level.

13. The method of claim 9, wherein each of the events stored in the event store and associated with a particular hierarchical level of the respective hierarchical levels is determinable entirely from information of others of the events associated with ones of the respective hierarchical levels that are below the particular hierarchical level.

14. The method of claim 1, wherein the determining is further based at least in part on one or more previously stored events of the event store.

15. The method of claim 1, wherein
the receiving is associated with a current time,
the received events are associated with the current time, and
at least one of the derived events is associated with the current time.

16. The method of claim 1, wherein
the receiving is associated with a current time,
the received events are current received events,
at least one of the derived events is further based at least in part on one or more earlier received events, and
the earlier received events were received at an earlier time that is earlier than the current time.

17. The method of claim 16, wherein the at least one of the derived events is associated with the current time.

18. The method of claim 16, wherein the at least one of the derived events comprises a count of the current received events and the earlier received events.

19. The method of claim 16, wherein the at least one of the derived events comprises an indicator that the current received events and the earlier received events collectively indicate that less than a threshold number of events matching one or more criteria have been received.

20. The method of claim 16, wherein
the event store comprises at least a current index of a plurality of indexes,
the storing of the received events comprises adding the received events to the current index, and
the earlier received events were added to the current index previous to the adding of the received events.

21. The method of claim 20, wherein the event store comprises a plurality of processing systems.

22. The method of claim 21, wherein at least respective first and second portions of the processing systems are respectively located in at least two respective distinct locations.

23. The method of claim 22, wherein at least respective portions of at least the current index are respectively maintained at the at least two respective distinct locations.

24. The method of claim 21, wherein at least respective first and second portions of the processing systems are respectively located in a same location.

25. The method of claim 24, wherein at least respective portions of at least the current index are respectively maintained at the same location.

26. The method of claim 16, wherein
the event store comprises at least a current index of a plurality of indexes each managed according to respective temporal storage ranges, and
the current time and the earlier time are included in the respective temporal storage range that the current index is managed according to.

27. The method of claim 26, wherein the event store comprises a plurality of processing systems.

28. The method of claim 27, wherein at least respective first and second portions of the processing systems are respectively located in at least two respective distinct locations.

29. The method of claim 28, wherein at least respective portions of at least the current index are respectively maintained at the at least two respective distinct locations.

30. The method of claim 27, wherein at least respective first and second portions of the processing systems are respectively located in a same location.

31. The method of claim 30, wherein at least respective portions of at least the current index are respectively maintained at the same location.

32. The method of claim 1, wherein
at least one of the derived events is based solely on a particular set of the received events,
each element of the particular set has an associated respective identifier, and
the at least one derived event is stored in the event store by storing the associated respective identifiers.

33. The method of claim 1, wherein
at least one of the derived events is based solely on a particular set of the received events, and
the at least one derived event is stored in the event store by storing a search specification that enables determining the particular set.

34. The method of claim 1, wherein
at least one of the derived events is based solely on a particular set of the received events, and
the at least one derived event is stored in the event store by a selected one of a plurality of selectable actions.

35. The method of claim 34, wherein the selected selectable action is selected based at least in part on a number of the elements.

36. The method of claim 35, wherein in response to the number being less than a selectable threshold, the selected selectable action comprises storing respective information associated with each of the elements.

37. The method of claim 36, wherein the respective information associated with the respective element comprises an identifier of the respective element.

38. The method of claim 35, wherein in response to the number being greater than a selectable threshold, the selected selectable action comprises storing a search specification that enables determining the particular set.

39. The method of claim 1, wherein the storing comprises indexing to enable searching.

40. An apparatus comprising:
a networking sub-system enabled to receive one or more events via one or more networks;
a storage sub-system enabled to store representations of the received events;
a processing sub-system coupled to the networking sub-system and the storage sub-system; and
wherein the processing sub-system is enabled to
associate each of the received events with a respective hierarchical level,
store, in the processing sub-system, the received events in accordance with the respective hierarchical levels, and
determine one or more derived events based at least in part on one or more of the received events.

41. The apparatus of claim 40, wherein the respective hierarchical levels comprise a base hierarchical level and one or more additional hierarchical levels.

42. A tangible computer readable medium having a set of instructions stored therein that when executed by a processing element cause the processing element to perform and/or control operations comprising:
receiving, by an event store, one or more events;
associating each of the received events with a respective hierarchical level;
storing, in the event store, the received events in accordance with the respective hierarchical levels; and
determining one or more derived events based at least in part on one or more of the received events.

43. The tangible computer readable medium of claim 42, wherein the respective hierarchical levels comprise a base hierarchical level and one or more additional hierarchical levels.

44. A system comprising:
means for receiving, by an event store, one or more events;
means for associating each of the received events with a respective hierarchical level;
means for storing, in the event store, the received events in accordance with the respective hierarchical levels; and
means for determining one or more derived events based at least in part on one or more of the received events.

45. The system of claim 44, wherein the respective hierarchical levels comprise a base hierarchical level and one or more additional hierarchical levels.
